(19) United States
(12) Patent Application Publication
(10) Pub. No.: US 2018/0161897 A1
(43) Pub. Date: Jun. 14, 2018

(54) INDUCTIVE ELECTROCHEMICAL MACHINING DEVICE

(71) Applicant: METAL INDUSTRIES RESEARCH & DEVELOPMENT CENTRE, KAOHSIUNG CITY (TW)

(72) Inventors: ZHI-WEN FAN, KAOHSIUNG CITY (TW); CHIN-WEI LIU, KAOHSIUNG CITY (TW); DA-YU LIN, KAOHSIUNG CITY (TW); YOU-LUN CHEN, KAOHSIUNG CITY (TW); KUN-CHIN LAN, KAOHSIUNG CITY (TW); CHEN-WEI WU, KAOHSIUNG CITY (TW); CHIN-HUNG WEN, KAOHSIUNG CITY (TW)

(21) Appl. No.: 15/374,025

(22) Filed: Dec. 9, 2016

(51) Int. Cl. B23H 3/04; B23H 7/12

(52) U.S. Cl. CPC B23H 3/04; B23H 7/12

(57) ABSTRACT

The present invention provides an inductive electrochemical machining device, which comprises a base, an inductive machining electrode, and a negative cleaning module. The base includes a workpiece machining zone. The inductive machining electrode is disposed on the base and corresponds to said workpiece machining zone. The negative cleaning module is opposing to the inductive machining electrode. When the inductive machining electrode performs electrochemical machining, the generated induction current may be used for machining. In addition, the surface of the inductive machining electrode may be cleaned concurrently by the negative cleaning module.

### FIELD OF THE INVENTION

The present invention relates generally to an electrochemical machining device, and particularly to an inductive electrochemical machining device.

### BACKGROUND OF THE INVENTION

An electrochemical process is a non-tradition process that makes use of the anode dissolution principle to forming a workpiece. For metal materials or high-hardness alloys that are difficult to be removed by mechanical forces, forming may be performed by using electrochemical processes. There will be no residual stress on the surface of a processed workpiece. No stress concentration in a workpiece occurs after electrochemical processes are completed. On the contrary, if knives are adopted for removing the workpiece mechanically, owing to the machining stress on the processed surface, the lifetime of the processed workpiece will be shortened.

### SUMMARY

An objective of the present invention to provide an inductive electrochemical machining device for performing inductive electrochemical processes as well as cleaning the surface of the machining electrode of the inductive electrochemical machining device concurrently.

The present invention provides an inductive electrochemical machining device, which comprises a base, an inductive machining electrode, and a negative cleaning module. The base includes a workpiece machining zone. The inductive machining electrode is disposed on the base and corresponds to said workpiece machining zone. The negative cleaning module is opposing to the inductive machining electrode. Thereby, the inductive electrochemical machining device may perform inductive electrochemical processes on the workpiece located in the workpiece machining zone. In addition, the surface of the inductive machining electrode may be cleaned concurrently.

### BRIEF DESCRIPTION OF THE DRAWINGS

FIG. 1 shows a front stereoscopic view of the inductive electrochemical machining device according to an embodiment of the present invention;

FIG. 2 shows a back stereoscopic view of the inductive electrochemical machining device according to an embodiment of the present invention;

FIG. 3 shows a side view of the inductive electrochemical machining device according to an embodiment of the present invention; and

FIG. 4 shows a machining schematic diagram of the inductive electrochemical machining device according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

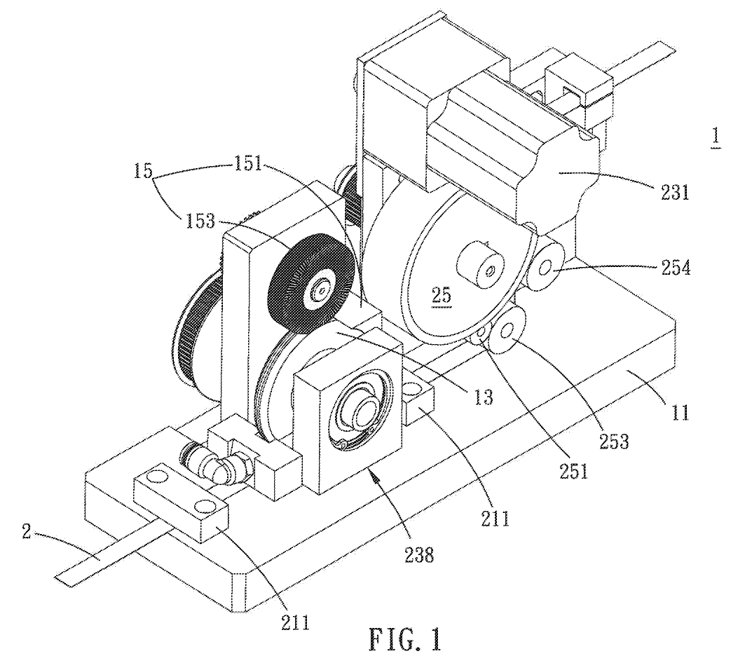

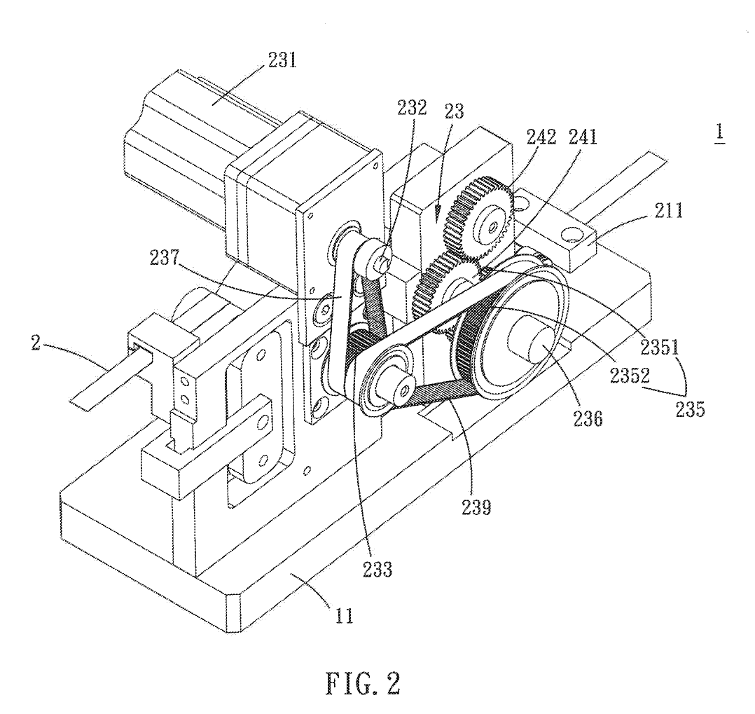

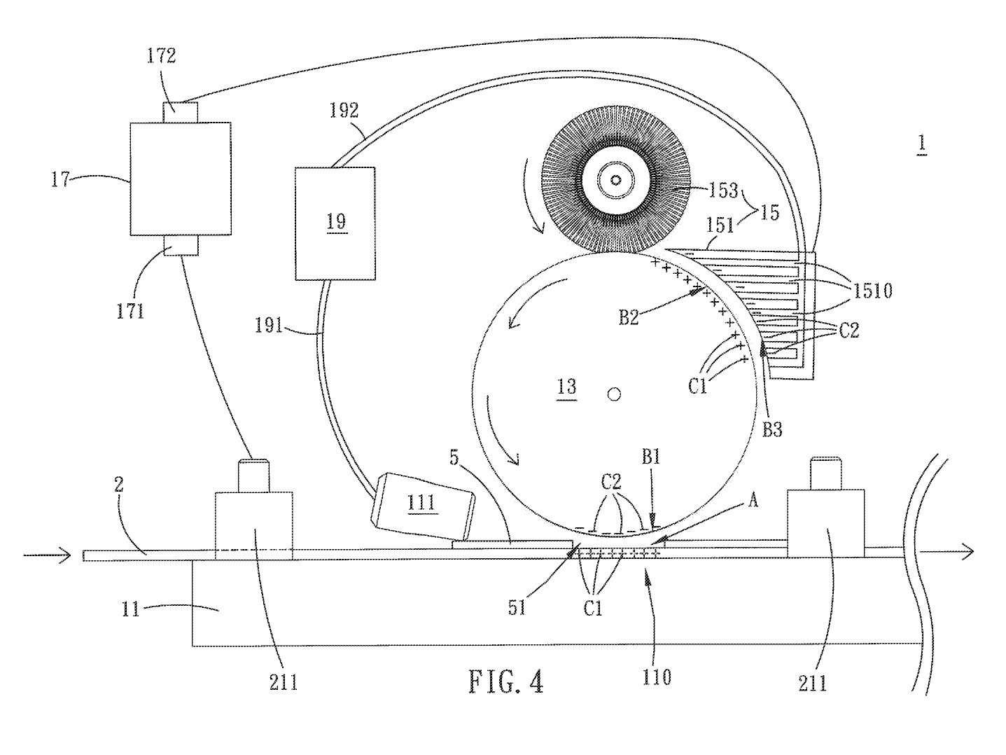

Please refer to FIG. 1 and FIG. 2, which show stereoscopic diagrams of the inductive electrochemical machining device according to the present invention in two different viewing angle. As shown in the figures, the inductive electrochemical machining device 1 comprises a base 11, an inductive machining electrode 13, and a negative cleaning module 15. A workpiece 2 and the negative cleaning module 15 correspond to the inductive machining electrode 13, respectively. A power supply module 17 (as shown in FIG. 4) is connected electrically with the workpiece 2. Thereby, the workpiece 2 may include a plurality of positive charges. The power supply module 17 may also be connected electrically with the negative cleaning module 15 and enabling the negative cleaning module 15 to include a plurality of negative charges.

An electrolyte is supplied between the workpiece 2 and the inductive machining electrode 13 and between the negative cleaning module 15 and the inductive machining electrode 13. When the inductive electrochemical machining device 1 performs electrochemical machining, as shown in FIG. 4, a plurality of negative charges will be induced on the surface B1 of the inductive machining electrode 13 corresponding to the plurality of positive charges on the workpiece 2 (the surface A). Namely, the surface B1 of the inductive machining electrode 13 opposing to the workpiece 2 (the surface A) includes the plurality of negative charges. Thereby, the inductive machining electrode 13 may perform electrochemical machining on the workpiece 2. Likewise, as shown in FIG. 4, a plurality of positive charges will be induced on the surface B2 of the inductive machining electrode 13 corresponding to the plurality of negative charges on the negative cleaning module 15 (the surface B3). Thereby, the negative cleaning module 15 may perform electrochemical machining on the surface B2 of the inductive machining electrode 13, and thus cleaning the surface of the inductive machining electrode 13. Accordingly, the inductive electrochemical machining device 1 may simplify the required power supply circuitry. The details will be described as follows.

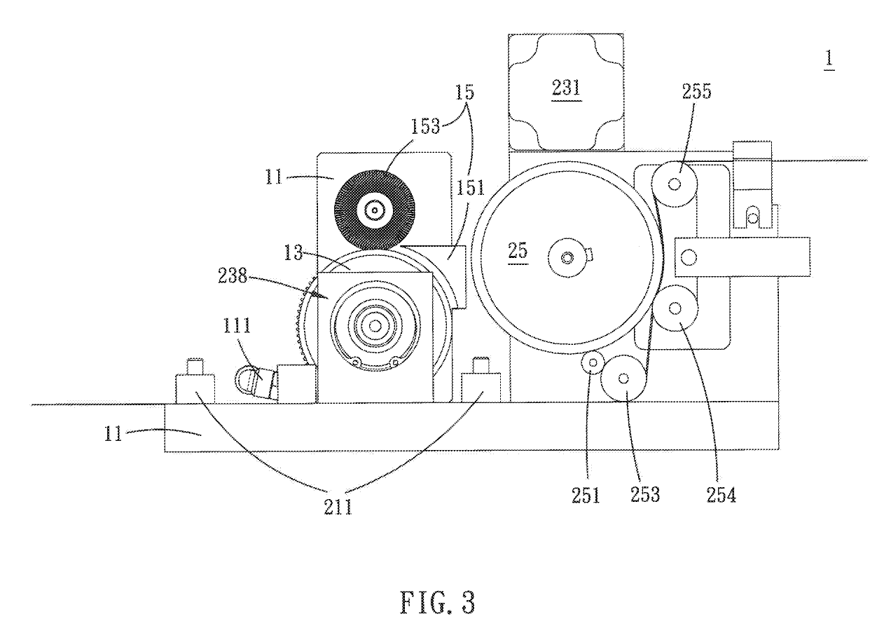

Please refer to FIG. 3 and FIG. 4, which show a side view and a machining schematic diagram of the inductive electrochemical machining device according to the present invention. As shown in the figures, the base 11 includes a workpiece machining zone 110. The inductive machining electrode 13 is disposed on the base 11 corresponding tot eh workpiece machining zone 110. The negative cleaning module 15 is opposing to the inductive machining electrode 13.

According to the present embodiment, the inductive electrochemical machining device 1 comprises the power supply module 17. A first electrode 171 of the power supply module 17 is connected electrically with the workpiece 2 to be processed. The workpiece is moved to the workpiece machining zone 110 of the base 11. A second electrode 172 of the power supply module 17 is connected electrically with the negative cleaning module 15. The negative cleaning module 15 is disposed on the base 11 and includes a cleaning electrode 15 and a wheel brush 153. The second electrode 172 of the power supply module 17 is connected electrically with the cleaning electrode 151 and the cleaning electrode 151 is opposing to the inductive machining electrode 13. According to an embodiment of the present invention, the power supply module 17 may be a DC power supply module, and the first and second electrodes 171, 172 may be a positive electrode and a negative electrode, respectively. In addition, according to another embodiment of the present invention the power supply module 17 may be an AC power supply module. According to requirements, the times of the positive half cycle and the negative half cycle may be adjusted. Thereby, according to the present invention the power supply module 17 is not limited a certain type.

The inductive electrochemical machining device 1 further comprises a cover member 5 located in the workpiece machining zone 110 and between the workpiece 2 and the inductive machining electrode 13. The cover member 5 includes an opening 51 opposing to the inductive machining electrode 13. The cover member 5 is used for covering the inductive machining electrode 13. The surface B on the inductive machining electrode 13 opposing to the opening 51 of the cover member 5 may be opposing to the workpiece machining zone through the opening 51 and hence opposing to the surface A of the workpiece 2 in the workpiece machining zone 110 for performing electrochemical machining on the surface A of the workpiece 2. Thereby, the opening 51 of the cover member 5 determines the area of the inductive machining electrode 13 opposing to the workpiece machining zone 110 and the workpiece 2 (the surface A).

The surface B3 of the cleaning electrode 151 is opposing to the surface B2 of the inductive machining electrode 13. According to the present embodiment, the area of the surface B3 of the cleaning electrode 151 is greater than the area of the opening 51 of the cover member 5. Thereby, the area of the surface B3 of the cleaning electrode 151 is greater than the area of the surface B1 of the inductive machining electrode 13. The surface B1 of the inductive machining electrode 13 is opposing to the workpiece machining zone 100 and the surface A of the workpiece 2. Hence, the induction current (the machining current) density between the cleaning electrode 151and the inductive machining electrode 13 is smaller than the induction current (the machining current) density between the inductive machining electrode 13 and the workpiece machining zone 100 (the workpiece 2). Consequently, the electrochemical machining amount on the surface A of the workpiece 2 is greater than that on the surface B2 of the inductive machining electrode 13. The induction current density described above may also be adjusted by altering the gap between the two objects and achieving the same effect. If the gap is larger, the current density is reduced.

According to the present embodiment, the inductive machining electrode 13 is a wheel-shaped electrode. The outline of the cleaning electrode 151 corresponds to the outline of the inductive machining electrode 13. In other words, the outline of the cleaning electrode 151 is opposing to the partial round outline of the wheel-shaped electrode and becomes curved. The wheel brush 153 is located on one side of the cleaning electrode 151, opposing to the inductive machining electrode 13, and contacts the surface of the inductive machining electrode 13. The wheel brush 153 cleans mechanically the electrochemically-cleaned surface of the inductive machining electrode 13.

Besides, the inductive electrochemical machining device 1 further comprises an electrolyte supplying module 19 for supplying electrolyte. The electrolyte supplying module 19 includes a first electrolyte supply pipe 191 and a second electrolyte supply pipe 192. An electrolyte supply unit 111 corresponds to the workpiece machining zone 110 and is disposed on the base 11. The first electrolyte supply pipe 191 communicates with the electrolyte supplying unit 111 and supplies electrolyte to the gap between the workpiece machining zone 110 and the inductive machining electrode 13. The cleaning electrode 151 includes a plurality of electrolyte supplying channel 1510. The outlets of the plurality of electrolyte supplying channels 1510 correspond to the inductive machining electrode 13. The second electrolyte supply pipe 192 communicates with the plurality of electrolyte supplying channels 1510 and supplies electrolyte to the gap between the cleaning electrode 151 and the inductive machining electrode 13.

In addition, the inductive electrochemical machining device 1 further comprises two alignment units 211 located before and after the workpiece machining zone 110, respectively and disposed on the base 11 for aligning and limiting the moving path of the workpiece 2. One of the alignment units 211 may further act as the electrical connector. The first electrode 171 of the power supply module 17 is connected electrically with the alignment unit 211. Because the alignment unit 211 will contact the workpiece 2, the power may be thus supplied to the workpiece 2.

Please refer again to FIG. 2 and FIG. 3. According to the present embodiment, the workpiece 2 may be a material strap. The inductive electrochemical machining device 1 may further comprises a transmission module disposed on the base 10 and drives the inductive machining electrode 13 and the wheel brush 153 to rotate and the workpiece 2 to move. Thereby, the inductive electrochemical machining device 1 may perform electrochemical machining on the workpiece 2 continuously. The transmission module according to the present embodiment is a transmission gear set 23 disposed on the base 10.

The transmission gear set 23 includes a driving unit 231, a first transmission gear 233, a second transmission gear 235, a first transmission belt 237, and a second transmission belt 239. According to an embodiment of the present invention, the driving unit 231 may be a motor. The transmission belt 237 is disposed between the first transmission gear 233 and a transmission shaft 232 of the driving unit 231. The second transmission belt 239 is disposed between the first transmission gear 233 and the second transmission gear 235. The first transmission gear 233 includes a wide gear body. The first transmission belt 237 is disposed at the inner gear body of the first transmission gear 233; the second transmission belt 239 is disposed at the outer gear body of the first transmission gear 233. As the transmission shaft 232 of the driving unit 231 rotates, it drives the first transmission belt 237 and thus driving the first transmission gear 233 to rotate. When the first transmission gear 233 rotates, it drives the second transmission belt 239 and thus driving the second transmission gear 235 to rotate.

Furthermore, the second transmission gear 235 includes an inner gear 2351 and an outer gear 2352 disposed coaxially. The second transmission belt 239 is disposed between the outer gear body of the first transmission gear 233 and the outer gear 2352 of the second transmission gear 235.When the outer gear 2352 of the second transmission gear 235 rotates, it drives the inner gear 2351 of the second transmission gear 235 to rotate together. The transmission gear set 23 further includes a third transmission gear 241 geared to the inner gear 2351 of the second transmission gear 235.

The transmission gear set 23 further includes a fourth transmission gear 242 geared to the third transmission gear 241. In addition, the fourth transmission gear 242 and the wheel brush 153 are disposed coaxially. As the fourth transmission gear 242 rotates, the wheel brush 153 rotates accordingly. The wheel brush 153 contacts the inductive machining electrode 13 and they rotate in the same direction (namely, both clockwise or both counterclockwise). The forces at the contact between the wheel brush 153 and the inductive machining electrode 13 are opposite. The inductive machining electrode 13 and the second transmission gear 235 are disposed coaxially. As the second transmission gear 235 rotates, the inductive machining electrode 13 rotates as well. Consequently, the second transmission gear 234 is equivalent to an electrode transmission gear. A transmission shaft 236 passes through the second transmission gear 235 and is disposed in a bearing module 238.

The transmission gear set 251 further includes a first workpiece transmission wheel 25, an idle wheel 251, and a plurality of second workpiece transmission wheels 253, 254, 255. The first workpiece transmission wheel 25 is located behind the workpiece machining zone 110. The first transmission gear 233 and the first workpiece transmission wheel 25 are disposed coaxially. When the first transmission gear 233 rotates, the first workpiece transmission wheel 25 rotates as well. The idle wheel 251 and the second workpiece transmission wheels 254, 255 correspond to the first workpiece transmission wheel 25. The idle wheel 251 is located between and contacts the first and second workpiece transmission wheels 25, 253. The rotational direction of the second workpiece transmission wheel 253 is the same as the rotational direction of the first workpiece transmission wheel 25. The rotational direction of the second workpiece transmission wheels 254, 255 is opposite to the rotational direction of the first workpiece transmission wheel 25.

The workpiece 2 is wound on one side of the second workpiece transmission wheel 253, and passes between the first and second workpiece transmission wheel 25, 254 and between the first workpiece transmission wheel 25 and the second workpiece transmission wheel 255. By using the first workpiece transmission wheel 25 and the plurality of second workpiece transmission wheels 253. 254, 255, the workpiece 2 may be move and hence continuous electrochemical processes may be performed.

Please refer again to FIG. 4. When the inductive electrochemical machining device 1 performs electrochemical machining, the electrolyte supplying module 19 supplies the electrolyte, which is provided to the gap between the workpiece 2 and the inductive machining electrode 13. In addition, the electrolyte is also provided to the gap between the cleaning electrode 151 and the inductive machining electrode 13 through the plurality of electrolyte supplying channels 1510 of the cleaning electrolyte 151.

Moreover, the first and second electrodes 171, 172 of the power supply module 17 are connected electrically to the workpiece 2 and the cleaning electrode 151 of the negative cleaning module 15, respectively, and thus enabling the workpiece 2 to have a plurality of positive charges C1 and the cleaning electrode 151 to have a plurality of negative charges C2. The surface B2 of the inductive machining electrode 13 will induce a plurality of positive charges C1 corresponding to the plurality of negative charges C2 of the cleaning electrodes 151; the surface B1 of the inductive machining electrode 13 will induce a plurality of negative charges C2 corresponding to the plurality of positive charges C1 of the workpiece 2. Thereby, the surface B1 of the inductive machining electrode 13 is equivalent to the cathode, while the workpiece 2 is equivalent to the anode. Then the surface B1 of the inductive machining electrode 13 may perform electrochemical machining on the workpiece 2. Besides, the surface B2 of the inductive machining electrode 13 is equivalent to the cathode, while the cleaning electrode 151 is equivalent to the anode. Then the cleaning electrode 151 may perform electrochemical machining on the surface B2 of the inductive machining electrode 13 and hence removing the impurities or products attached to the surface B2 of the inductive machining electrode B2.

As shown in FIG. 2 and FIG. 3, the driving unit 231 drives the first transmission gear 233 to rotate and hence driving the first workpiece transmission wheel 25 to rotate. Thereby, the first workpiece transmission wheel 25 and the plurality of second workpiece transmission wheels 253, 254, 255 drive the workpiece 2 to move, and thus moving the processed segment of the workpiece 2 away of the workpiece machining zone 110. When the first transmission gear 233 rotates, the second transmission gear 235 will be driven to rotate as well and hence driving the inductive machining electrode 13 to rotate. Thereby, the processed segment of the inductive machining electrode 13 is moved away from the workpiece machining zone 110. The processed segment of the inductive machining electrode 13 will no longer perform electrochemical process. Instead, it will correspond the cleaning electrode 151 for cleaning. The unprocessed segment (the cleaned segment) of the inductive machining electrode 13 will be moved above the workpiece machining zone 110 for subsequent electrochemical machining.

Furthermore, as the second transmission gear 235 rotates, it will drive the third transmission gear 241 to rotate. The third transmission gear 241, in turn, drives the fourth transmission gear 242 to rotate and finally driving the wheel brush 153 to rotate. The wheel brush 153 contacts the surface of the inductive machining electrode 13. It removes the machining products or impurities on the surface of the inductive machining electrode 13 mechanically.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An inductive electrochemical machining device, comprising:
a base, having a workpiece machining zone;
an inductive machining electrode, disposed on said base, and corresponding to said workpiece machining zone; and
a negative cleaning module, opposing to said inductive machining electrode.

2. The inductive electrochemical machining device of claim 1, further comprising a power supply module, said power supply module having a first electrode and a second electrode, said negative cleaning module connected electrically to said second electrode of said power supply module and having a plurality of negative charges, said inductive machining electrode inducing a plurality of positive charges by corresponding to said plurality of negative charges of said negative cleaning module, and said inductive machining electrode having a plurality of negative charges at the location corresponding to said workpiece machining zone.

3. The inductive electrochemical machining device of claim 1, wherein said inductive machining electrode is a wheel-shaped electrode.

4. The inductive electrochemical machining device of claim 1, wherein said negative cleaning module further including a cleaning electrode opposing to said inductive machining electrode.

5. The inductive electrochemical machining device of claim 4, wherein the outline of said cleaning electrode corresponds to the outline of said inductive machining electrode.

6. The inductive electrochemical machining device of claim 5, wherein the area of a surface of said cleaning electrode opposing to said inductive machining electrode is greater than the area of a surface of said inductive machining electrode opposing to said workpiece machining zone; and an induction current density between said cleaning electrode and said inductive machining electrode is smaller than an induction current density between said inductive machining electrode and said workpiece machining zone.

7. The inductive electrochemical machining device of claim 4, wherein said negative cleaning module further includes a wheel brush located on one side of said cleaning electrode and opposing to said inductive machining electrode.

8. The inductive electrochemical machining device of claim 1, further comprising an electrolyte supplying unit disposed on said base and corresponding to said workpiece machining zone, said negative cleaning module having a plurality electrolyte supplying channels, and the outlets of said plurality of electrolyte supplying channels corresponding to said inductive machining electrode.

9. The inductive electrochemical machining device of claim 1, further comprising a transmission module disposed on said base and driving said inductive machining electrode to move.

10. The inductive electrochemical machining device of claim 9, wherein said transmission module includes an electrode transmission wheel, a first workpiece transmission wheel, and one or more second workpiece transmission wheels; said electrode transmission wheel drives said inductive machining electrode to rotate; and said second workpiece transmission wheel corresponds to said first workpiece transmission wheel.
